(19) United States
(12) Patent Application Publication
(10) Pub. No.: US 2023/0137781 A1
(43) Pub. Date: May 4, 2023

(54) MODULAR ADDITIVE MANUFACTURING PROCESS

(71) Applicant: MATTHEWS INTERNATIONAL CORPORATION, Pittsburgh, PA (US)

(72) Inventors: Jake A. VARGO, Washington, PA (US); Bernard A. KUHN, Jr., Baden, PA (US); Gregory A. GEERS, Upper St. Clair, PA (US)

(21) Appl. No.: 17/978,424

(22) Filed: Nov. 1, 2022

Related U.S. Application Data
(60) Provisional application No. 63/274,163, filed on Nov. 1, 2021.

(51) Int. Cl. B22C 9/02; B33Y 10/00; B22C 9/12; B28B 1/00; B28B 11/24

(52) U.S. Cl. CPC B22C 9/02; B33Y 10/00; B22C 9/12; B28B 1/001; B28B 11/24

(57) ABSTRACT

Improved processes for generating a mold configured for casting—are disclosed. An illustrative process comprises using one or more 3D sand printers to create interlocking modular pieces that, when assembled, form the mold. The interlocking modular pieces may be used to define cavities such as a pattern cavity, a sprue, a riser, a runner, or a vent. Additionally, the interlocking modular pieces may define cores to fit inside the pattern cavity.

### CROSS-REFERENCE TO RELATED APPLICATIONS

The present application claims priority to and benefit of U.S. Provisional Application No. 62/274,163 filed Nov. 1, 2021, the disclosure of which is hereby incorporated by reference herein in its entirety.

### TECHNICAL FIELD

The present application relates to metal casting processes. Three-dimensional sand printers are utilized to create layered, interlocking pieces of a mold.

### BACKGROUND

Metal casting is used to form complex shapes that would be difficult or uneconomical to form by other methods, such as forging or machining. Metal casting apparatuses and processes are themselves varied in complexity and cost, and it has become accepted in industry to utilize certain metal casting techniques for certain applications. Furthermore, certain techniques, because they are broadly suitable, continue to be employed even when those techniques have material drawbacks.

Sand mold casting is conventionally used for most ferrous and non-ferrous parts requiring moderate to high levels of detail but where surface finish and dimensional accuracy are not excessively critical. A pattern or part is used to form a mold from a mixture of silica sand and binder. Sand mold casting is generally cost effective, but the formation of sand molds is a manual process requiring a high degree of operator skill.

For ferrous and non-ferrous castings requiring high levels of detail, uniform surface finish, and excellent dimensional tolerance, conventional methods employ a lost-wax process or its more recent variant, the investment casting process. These techniques permit castings with a high level of detail, dimensional accuracy, and surface texture or smoothness as the part requires. However, the equipment and procedures required for the lost wax or investment casting processes are expensive and time consuming. For example, the lost-wax and investment casting processes require additional steps to prepare the mold that add to the required time and cost which are not incurred for sand casting.

Recently 3D printers, sometimes referred to as additive manufacturing, have provided new options for molds, such as sand casting molds. A 3D printed sand mold may provide increased mold accuracy, allowing such molds to economically serve more applications that would otherwise require investment casting or excessive post-casting polishing and machining steps. However, as in all molding operations, casting parts that are both very large and very complex is challenging. For example, using 3D printers for sand casting comes with risks associated with error in prints, which is compounded by the low speed of many such 3D printers. Because prints for an entire mold could take twenty-four hours or more depending upon the size of the mold, reprinting an entire mold would significantly delay a project. Errors in such printed molds, if located in a place that cannot be easily inspected, may not be noticed until the casting operation is completed and the final part inspected, leading to costly recasting and rework. As such, a need exists for 3D printed molds and processes and apparatus for making the same that avoid the foregoing drawbacks for cast parts.

### SUMMARY

In some embodiments, a method is directed to forming a modular 3D printed mold from a plurality of 3D printed mold modules, the method including: depositing additive material in accordance with a first digital 3D model to form a first green body; hardening the first green body to form a first 3D printed mold module; depositing additive material in accordance with a second digital 3D model to form a second green body; hardening the second green body to form a second 3D printed mold module; and moving the first 3D printed mold module into close proximity with the second 3D printed mold module to thereby form the modular 3D printed mold.

In some embodiments, the method further includes inspecting at least one of the first 3D printed mold module and the second 3D printed mold module for defects.

In some embodiments, the method further includes detecting a defect of predetermined classification in one of the first 3D printed mold module or the second 3D printed mold module; removing from production the 3D printed mold module that contains the defect; depositing additive material in accordance with the first digital 3D model or the second digital 3D model in order to form a first green body or second green body; hardening the first green body or the second green body to replace the 3D printed mold module that contains the defect; performing a test to detect whether a defect of predetermined classification exists in the third 3D printed mold module; and moving the third 3D printed mold module into close proximity with the remaining first 3D printed mold module or second 3D printed mold module to thereby form the modular 3D printed mold.

In some embodiments, the first 3D printed mold module includes a protruding surface feature and the second 3D printed mold module includes a correspondingly shaped sunken surface feature.

In some embodiments, the first 3D printed mold module and the second 3D printed mold module are formed by a single 3D printer.

In some embodiments, the first 3D printed mold module and the second 3D printed mold module are formed by separate 3D printers.

In some embodiments, a method is directed to forming a casting, the method including: depositing additive material in accordance with a first digital 3D model to form a first green body; hardening the first green body to form a first 3D printed mold module; depositing additive material in accordance with a second digital 3D model to form a second green body; hardening the second green body to form a second 3D printed mold module; moving the first 3D printed mold module into close proximity with the second 3D printed mold module to thereby form the modular 3D printed mold; depositing molten metal into the modular 3D printed mold; and hardening the molten metal contained within the modular 3D printed mold.

In some embodiments, the method further includes separating the hardened metal from the modular 3D printed mold.

In some embodiments, separating the hardened metal from the modular 3D printed mold includes shaking the mold.

In some embodiments, the first 3D printed mold module includes a protruding surface feature and the second 3D printed mold module includes a correspondingly shaped sunken surface feature.

In some embodiments, the protruding surface feature and the correspondingly shaped sunken surface feature are nonsymmetrical.

In some embodiments, moving the first 3D printed mold module into close proximity with the second 3D printed mold module to thereby form the modular 3D printed mold further includes aligning the protruding surface feature with the correspondingly shaped sunken surface.

In some embodiments, aligning the protruding surface feature with the correspondingly shaped sunken surface is configured to align at least one of a pattern cavity, sprue, riser, runner, or vent present in both the first 3D printed mold module and the second 3D printed mold module.

In some embodiments, the method further includes: forming a 3D printed core by depositing additive material in accordance with a third digital 3D model to form a third green body and hardening the third green body; and nesting the 3D printed core within the modular 3D printed mold formed by the first 3D printed mold module and the second 3D printed mold module.

In some embodiments, a computer program product is directed to forming a modular 3D printed mold from a plurality of 3D printed mold modules, wherein the computer program product is embodied by instructions on a non-transitory computer readable storage medium that, when executed by a processor, cause: at least one 3D printer to deposit additive material to form a first 3D printed mold module in accordance with a first digital 3D model to form a first green body; and at least one 3D printer to deposit additive material to form a second 3D printed mold module in accordance with a second digital 3D model to form a second green body wherein the first 3D printed mold module includes a protruding surface feature and the second 3D printed mold module includes a correspondingly shaped sunken surface feature.

### BRIEF DESCRIPTION OF THE DRAWINGS

The aspects and embodiment of this application are depicted in the figures, wherein:

FIG. 1 depicts a side view of a 3D printed mold module of a modular 3D printed mold in accordance with an embodiment.

FIG. 2 depicts an overhead view of a 3D printed mold module of a 3D printed mold in accordance with an embodiment.

FIG. 3 depicts a side view of multiple interlocked 3D printed mold modules forming a portion of a modular 3D printed mold in accordance with an embodiment.

FIG. 4 depicts an overhead view of multiple interlocked 3D printed mold modules forming a portion of a modular 3D printed mold in accordance with an embodiment.

FIG. 5 depicts a modular core component in accordance with an embodiment.

FIG. 6 depicts an illustrative digital 3D model of the modular 3D printed mold and components required to cast a boot in accordance with embodiment.

FIG. 7 depicts an overhead view of the example digital 3D model presented in FIG. 6.

FIG. 8 depicts a plurality of 3D printed mold modules and core pieces based on the design depicted in FIGS. 6 and 7.

FIGS. 9A-9F depict a method of assembling 3D printed mold modules into a modular 3D printed mold including the plurality of 3D printed mold modules and core pieces depicted in FIG. 8.

FIG. 10 depicts the completed modular 3D printed mold from the assembly of the plurality of 3D printed mold modules and core pieces depicted in FIGS. 9A-9F.

FIG. 11 depicts a casting generated using the modular 3D printed mold of FIG. 10.

### DETAILED DESCRIPTION

This disclosure is not limited to the particular systems, devices and methods described, as these may vary. The terminology used in the description is for the purpose of describing the particular versions or embodiments only and is not intended to limit the scope of the disclosure.

The following terms shall have, for the purposes of this application, the respective meanings set forth below. Unless otherwise defined, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention.

As used herein, the singular forms “a,” “an,” and “the” include plural references, unless the context clearly dictates otherwise. Thus, for example, reference to a “cell” is a reference to one or more cells and equivalents thereof known to those skilled in the art, and so forth.

As used herein, the term “about” means plus or minus 10% of the numerical value of the number with which it is being used. Therefore, about 50 mm means in the range of 45 mm to 55 mm.

As used herein, the term “consists of” or “consisting of” means that the device or method includes only the elements, steps, or ingredients specifically recited in the particular claimed embodiment or claim.

In embodiments or claims where the term “comprising” is used as the transition phrase, such embodiments can also be envisioned with replacement of the term “comprising” with the terms “consisting of” or “consisting essentially of.”

As will be understood by one skilled in the art, for any and all purposes, such as in terms of providing a written description, all ranges disclosed herein are intended as encompassing each intervening value between the upper and lower limit of that range and any other stated or intervening value in that stated range. All ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art, all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 components refers to groups having 1, 2, or 3 components as well as the range of values greater than or equal to 1 component and less than or equal to 3 components. Similarly, a group having 1-5 components refers to groups having 1, 2, 3, 4, or 5 components, as well as the range of values greater than or equal to 1 component and less than or equal to 5 components, and so forth.

In addition, even if a specific number is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, sample embodiments, or drawings, should be understood to contemplate the possibilities of including one of the terms, either of the terms, or both terms. For example, the phrase “A or B” will be understood to include the possibilities of “A” or “B” or “A and B.”

In addition, where features of the disclosure are described in terms of Markush groups, those skilled in the art will recognize that the disclosure is also thereby described in terms of any individual member or subgroup of members of the Markush group.

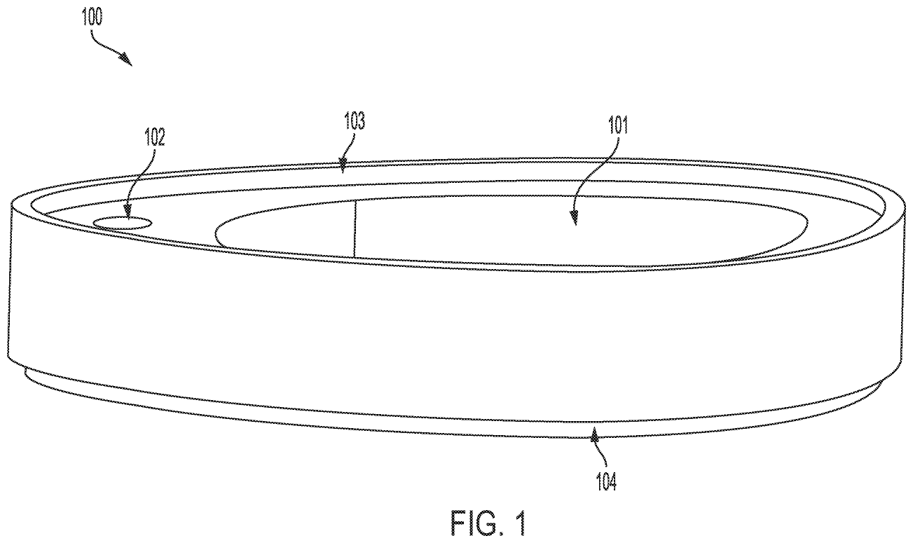

Referring to FIG. 1, a side view of a 3D printed mold module of a mold 100 is depicted in accordance with an embodiment. A 3D printed mold module 100 may be a green sand body. A 3D printed mold module 100 may be configured to be stacked with one or more 3D printed mold modules to form a complete mold. In certain embodiments, adjacent 3D printed mold modules 100 interlock using a raised edge 103 around the perimeter of the 3D printed mold module 100. The raised edge 103 may form a socket which accepts a recessed edge 104 on an adjacent interlocking 3D printed mold module. The raised edge 103 is one example of a protruding surface feature that can nest or otherwise interlock with a corresponding sunken surface feature. Therefore, in alternative embodiments, adjacent 3D printed mold modules may be nested or interlocked by bringing other protruding surface features into proximity or contact with sunken surface features of corresponding abutting surfaces of the adjacent 3D printed mold modules. Any complimentary surfaces may be used. Non-limiting examples include complimentary textures throughout the abutting surfaces or complementary ridges or recesses surrounding any cavities found within the 3D printed mold modules 100. In other embodiments, adjacent 3D printed mold modules may simply stack or feature protruding surface features or sunken surface features for clamping. In further embodiments, multiple interlocking methods are combined.

In certain embodiments, some of the one or more 3D printed mold modules 100 may comprise one or more cavities 101/102. In some embodiments, the one or more cavities may define a pattern cavity 101, sprue 102, riser, runner, or vent. In some embodiments, the one or more cavities may align with one or more corresponding cavities in adjacent interlocking 3D printed mold modules.

In some embodiments, the 3D printed mold module is configured with a nonsymmetrical raised or recessed portion. The nonsymmetrical portion may be configured to interlock similarly to the above referenced raised and recessed portion. Furthermore, the nonsymmetrical nature of the portions may allow a user to align adjacent layers during assembly of the mold. In some portions, the raised and recessed portions may be unique to a specific pair of adjacent 3D printed mold modules, making it clear which layers interlock and preventing incorrect assembly of the mold.

A person of ordinary skill in the art will note that the depicted 3D printed mold module 100 is purely illustrative in terms of its overall shape. It will be understood by skilled persons that the shape is not limited and can be designed to fit whichever cavities are required to form the modular 3D printed mold and ultimately the cast metal part.

The 3D printed mold module 100 may be printed using any known 3D printing systems or methods. Although sand is referenced herein, it will be understood by a skilled person that alternative materials, conducive to casting, may be used. Additionally, the 3D printing process may include one or more appropriate binding materials. In some embodiments, the 3D printer utilizes green sand. Depending on the binding methods used, the 3D printed mold module 100 may be hardened (e.g., drying, heating, applying CO₂) prior to use in casting.

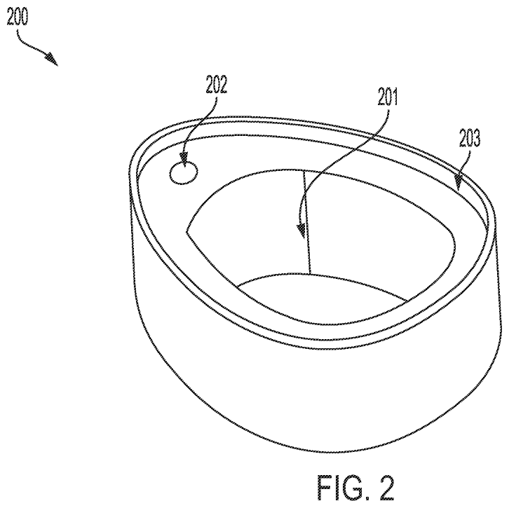

Referring briefly to FIG. 2, an alternative view of a 3D printed mold module 200 is depicted. As shown in FIG. 2, the cavities 201/202 and raised edge 203 of the 3D printed mold module 200 are clearly depicted.

In some embodiments, each modular 3D printed mold (not shown in FIG. 2) may be further divided into a plurality of 3D printed mold modules, such as 3D printed mold module 200. This may be advantageous for a number of reasons. For example, dividing a 3D printed mold into a plurality of 3D printed mold modules permits the rate limited task of printing each 3D printed mold module to be distributed among several 3D printers. In another example, dividing a 3D printed mold may allow the mold modules to be stored in a more space efficient manner. Such an embodiment can also permit more complex geometries to be formed through the preparation of more discrete 3D printed mold modules. In certain embodiments, two or more mold modules may interlock by nesting protruding surface features and sunken surface features. In other embodiments, two or more mold modules may be pushed together and locked into place by permitting a raised edge of a first 3D printed mold module to nest with a corresponding groove or other depression in a second 3D printed mold module that is located above or below the first module.

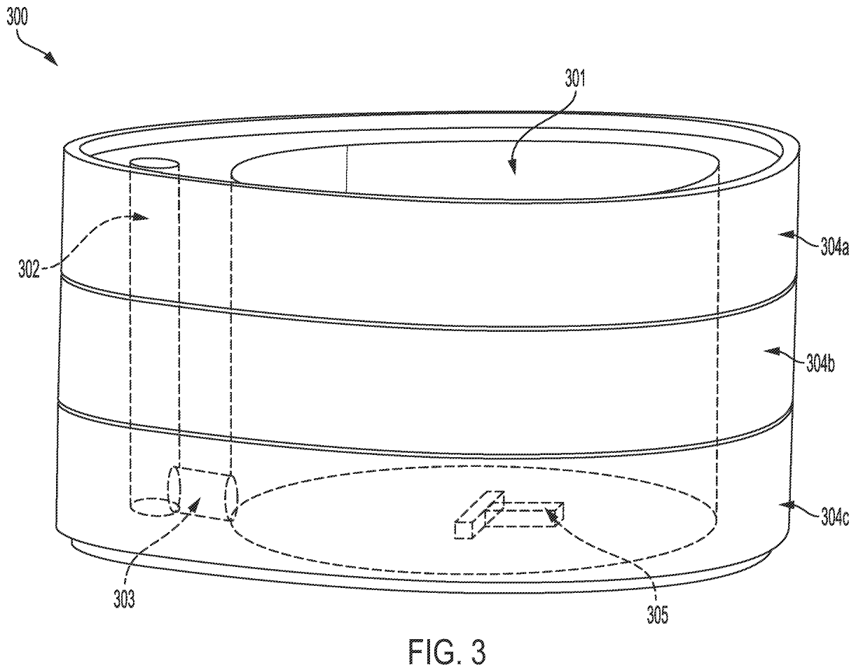

Referring to FIG. 3, a side view of multiple interlocked 3D printed mold modules 300, forming a portion of a mold, is depicted. The bottom 3D printed mold module 304c defines a base, a bottom portion of the pattern cavity 301, and a bottom portion of the sprue 302. As depicted in FIG. 3, the pattern cavity 301 and sprue 302 may each extend through other 3D printed mold modules, such as 304a/304b. In some embodiments, a runner 303 may join the sprue 302 to the pattern cavity 301 in the bottom 3D printed mold module 304c. In some embodiments, other cavities such as risers or vents may be incorporated into portions of the 3D printed mold modules 304a/304b/304c. In some embodiments, any of the one or more 3D printed mold modules 304a/304b/304c may comprise a raised or recessed region 305 configured to interlock with a core piece.

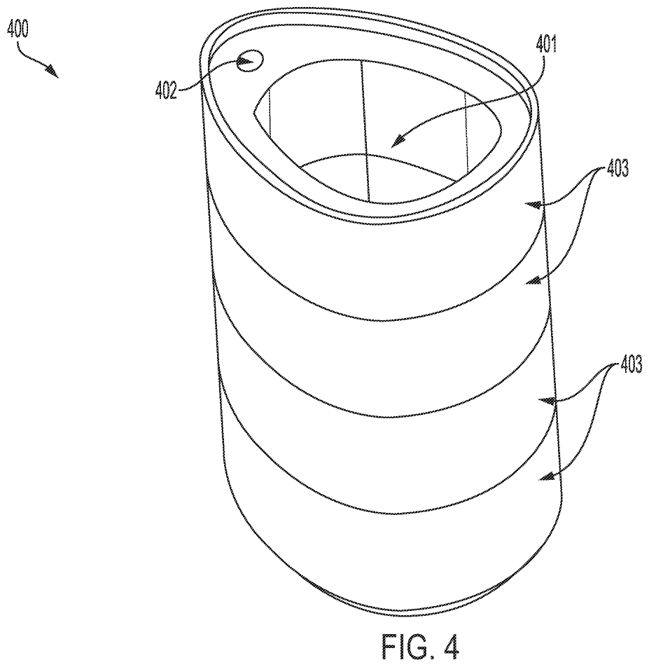

Referring briefly to FIG. 4, an alternative view of a 3D printed mold 400 formed from multiple interlocked 3D printed mold modules 403 is depicted. As shown in FIG. 4, cavities 401/402 may be present in a plurality of individual 3D printed mold modules 403.

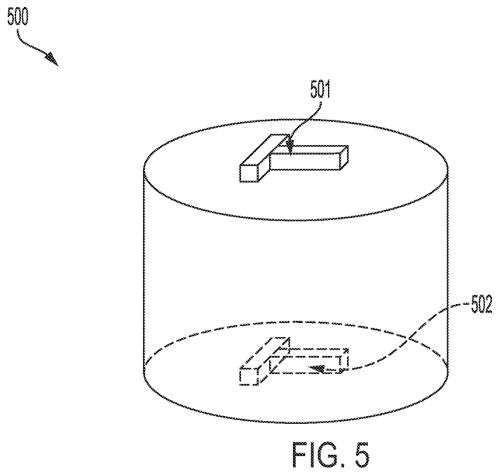

Referring to FIG. 5, a core piece 500 is depicted, in accordance with an embodiment. The core piece 500 is configured to fit within the pattern cavity of a mold. In some embodiments, the core piece 500 is configured to interlock with one or more additional core pieces. In further embodiments, the core piece 500 is configured to interlock with a 3D printed mold module as disclosed herein. In some embodiments, core pieces interlock through the use of a raised 501 or recessed 502 region that is complimentary to a region on an adjacent core piece.

In some embodiments, the raised 501 or recessed 502 portion is configured to be nonsymmetrical. The nonsymmetrical nature of the portions may allow a user to align adjacent core pieces during assembly of the mold. In some portions, interlocking raised and recessed portions may be unique to a specific pair of adjacent core pieces in order to assist in a determination of which core pieces are configured to interlock and thereby prevent incorrect assembly of the mold. For example, the raised 501 or recessed 502 portions may include a pattern of raised and recessed regions along some portion of the entire abutting surface of the core 500. In another example, the raised 501 or recessed 502 portions may include a raised edge for interlocking with an adjacent core.

A person of ordinary skill in the art will note that the depicted core piece 500, including the raised 501 and recessed 502 portions, is purely illustrative in terms of overall shape. The shape of a core piece 500 may be configured to properly fit inside one or more cavities required to form the mold.

The generation of three-dimensional models, as disclosed herein, is performed using a system comprising a processor and a non-transitory storage medium. In some embodiments, generic 3D modeling software (for example, Computer Aided Design software, which is commonly referred to as CAD software) may be used. In other embodiments, specific mold generation software or an extension to other 3D modeling software may be used to allow for increased automation.

In certain embodiments, the process of creating a mold comprises receiving or generating a digital 3D model of the object to be cast. In some embodiments, a physical object, which may or may not be at the final required scale, is scanned. The scanning of the physical object may be performed by any known method, including contact and non-contact methods. In some embodiments, the scanning is performed using a laser. In other embodiments, an artist generates the 3D digital model. In some embodiments, the model is of a file type readable by a 3D printer, such as a Standard Tessellation Language (STL) file.

In some embodiments, the process further comprises separate steps of generating one or more 3D printed mold modules and one or more cores which can thereby form a modular 3D printed mold. The form and assembly of the 3D printed mold modules and cores is not limited. It should be noted that although 3D printed mold modules and cores are typically assembled to fit together in a single design (i.e., a modular 3D printed mold), the disclosure is not so limited. Modular 3D printed molds, constituent 3D printed mold modules, and cores that are not used together in the formation of a single cast part can nevertheless be formed if it is so desired in accordance with this disclosure. In some embodiments, at least a portion of the mold is manufactured by other techniques, such as conventional casting techniques and combined with 3D printed modules and/or cores. In some embodiments, generating both the modular 3D printed mold and the core may be performed in an automated fashion, for example by using a file type that is readable by a 3D printer, including a STL file. In further embodiments, automation parameters may comprise one or more of material thickness, weight, and pour risk. In some embodiments, forming the modular 3D printed mold may further comprise generating one or more additional cavities, such as gates, risers, feeders, runners, or taps, within the modular 3D printed mold other than cavities required for the desired casting that is to be formed.

In certain embodiments, generating the modular 3D printed mold may further comprise dividing the modular 3D printed mold into one or more 3D printed mold modules. In certain embodiments, generating the core may further comprise dividing the modular 3D printed mold into one or more pieces. In some embodiments, dividing the modular 3D printed mold into one or more 3D printed mold modules and/or dividing the core into one or more pieces may be fully or partially automated. In some embodiments, the configuration of the interface between 3D printed mold modules may limit the number of divisions in one or more cavities. In some embodiments, the interface between adjacent 3D printed mold modules may be predominantly planar. In some embodiments, the interface between adjacent 3D printed mold modules may be curved. In further embodiments, the interface between adjacent 3D printed mold modules may feature raised and recessed portions. In some embodiments, each 3D printed mold module may be of approximately the same height to, for example, provide for ease of storage. In other embodiments, the 3D printed mold modules may be of different heights to limit risk in the pour and simplify refinishing on fine details.

In certain embodiments, the generated 3D printed mold modules may comprise a top layer with an interface for a pouring cup. In some embodiments, the interface is generic for interfacing a standard preexisting pouring cup. In some embodiments, a custom pouring cup is also modeled and 3D printed.

In certain embodiments, the generated 3D printed mold modules and core pieces are produced using a 3D printing process including a 3D printer. In some embodiments, the 3D printer is a sand printer. In some embodiments, the generated 3D printed mold modules and core pieces are analyzed to create assembly instructions for the modular 3D printed mold.

In certain embodiments, quality assurance may be performed on at least one of the 3D printed components. In some embodiments, the quality assurance comprises a visual inspection. In some embodiments, quality assurance comprises an automated scan of the 3D printed components. The scanning may be performed by any known method, including contact and non-contact methods. In some embodiments, the scanning is performed using a laser.

In certain embodiments, the components may be assembled into a completed modular 3D printed mold configured to form a casting from a digital 3D model.

### Example

As a non-limiting example, the process for developing a modular 3D printed mold and casting a boot design is described herein. A boot design is a difficult structure to cast, in part because various surface features are highly complex. The boot design was used as an illustrative structure that is complex enough to normally require lost wax or investment casting techniques. For example, the laces are spaced away from the overall substrate that is representative of the boot, which results in excess flashing or even complete fusion of the laces to the substrate in contravention of the original article. With conventional sand molding techniques, multiple casting attempts are typically required, resulting in wasted production time and consumables. In contrast, as will be depicted below, the disclosed method achieved an accurate representation of the boot in a single attempt, including the formation of laces spaced from the substrate.

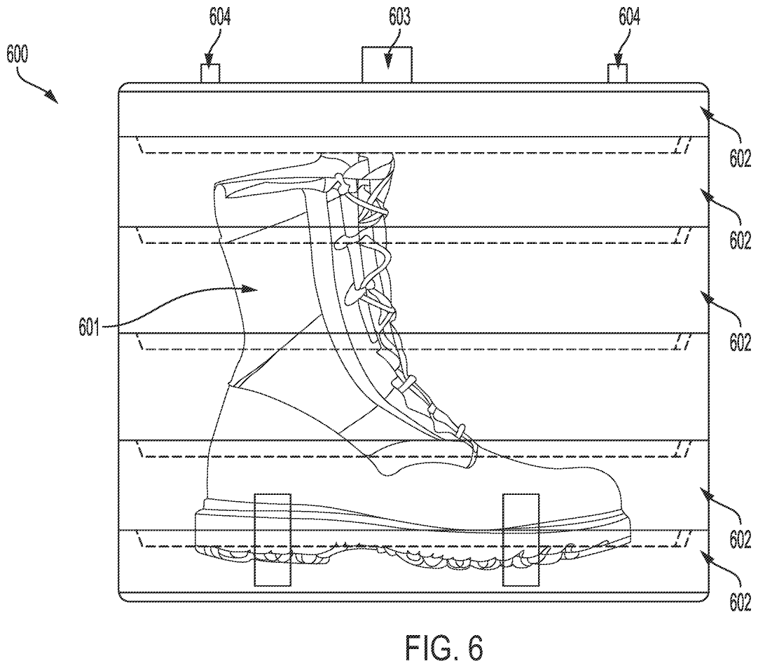

Referring to FIG. 6, a graphical rendering of a digital 3D model 600 of the plurality of 3D printed mold modules, cores, and other components required to cast a boot 601 is depicted. The components of the modular 3D printed mold include multiple 3D printed mold modules 602 into which the modular 3D printed mold has been divided, as disclosed in more detail herein. As shown in FIG. 6, the modular 3D printed mold and its constituent 3D printed mold modules further include a plurality of vents 604 and a location for installing a pouring cup 603.

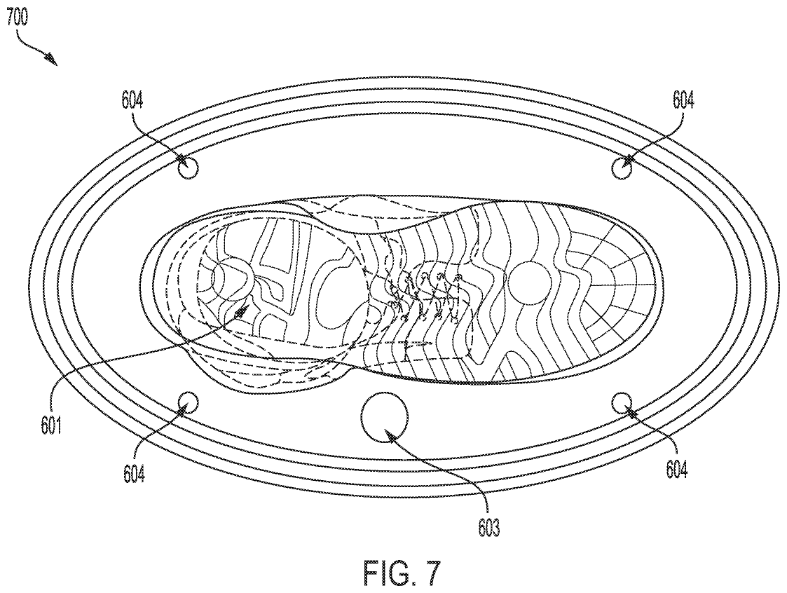

Referring to FIG. 7, an overhead perspective 700 of the digital 3D model from FIG. 6 is depicted. Multiple perspective views may be selected from within the system to allow a user to properly customize the modular 3D printed mold. The overhead perspective allows for a clear view of the vents 604 and pouring cup interface 603.

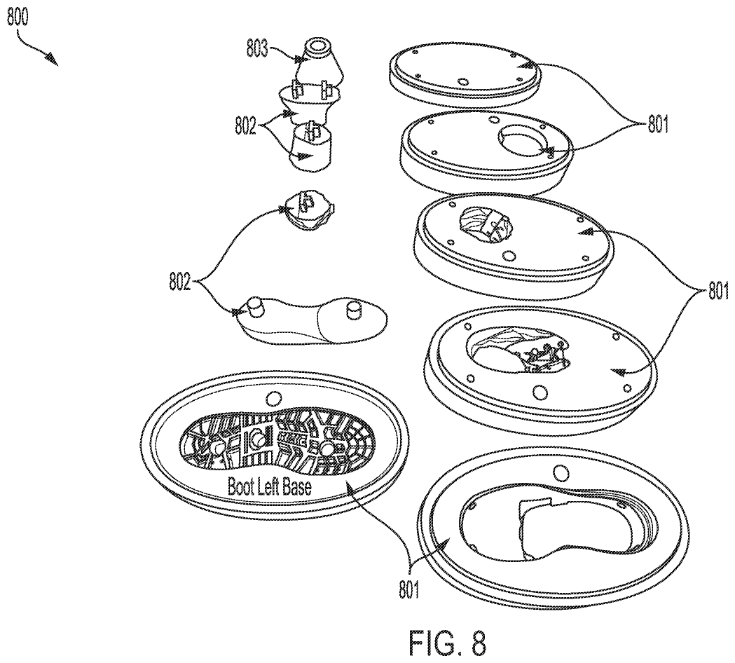

Referring briefly to FIG. 8, the 3D sand printed mold components 800 for the boot design are depicted. As shown in FIG. 8, the components comprise six layers 801, four core pieces, and a pour cup 803.

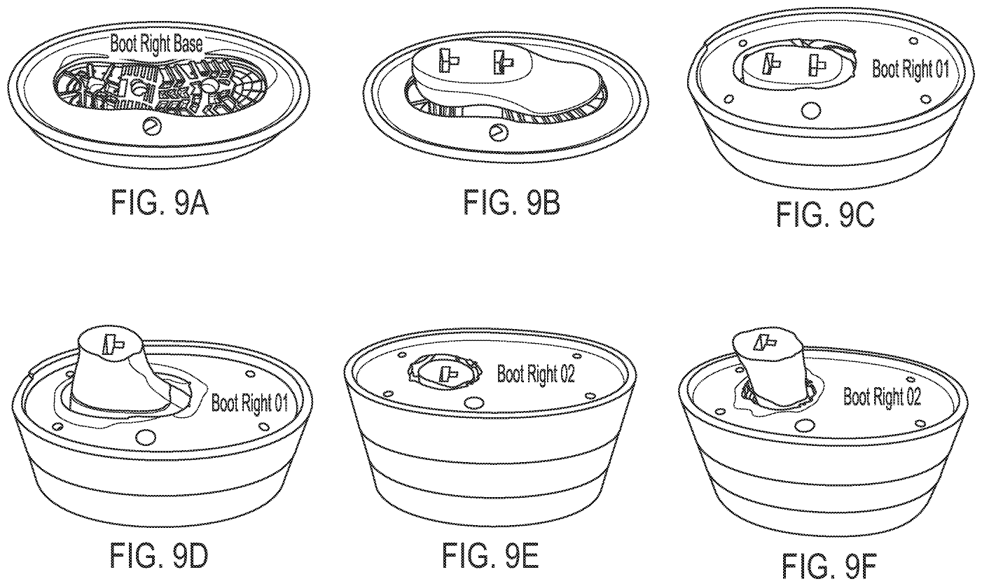

Referring briefly to FIGS. 9A-9F, the assembly process for the modular 3D printed mold is depicted. Due to the protruding surface features or sunken surface features, or both that are included in each 3D printed mold module, each additional component of the modular 3D printed mold can be aligned with minimal error.

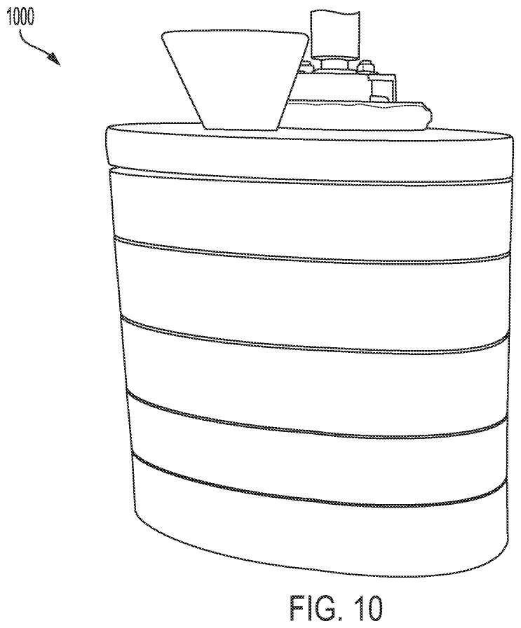

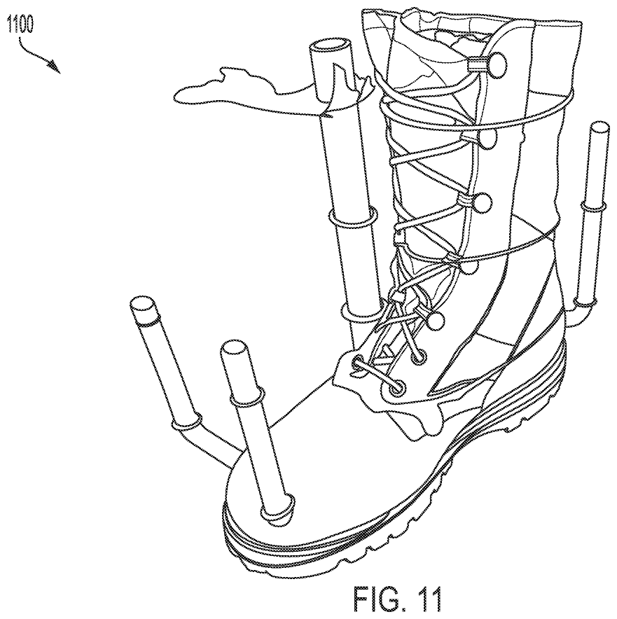

Referring briefly to FIG. 10, the complete assembled modular 3D printed mold 1000 is depicted. The modular 3D printed mold is now prepared for depositing a molten metal within, which is typically achieved by pouring the molten metal into the modular 3D printed mold and subsequently permitting the mold and the molten metal to cool. This solidifies the metal and forms a casting. Following the cast, the casting is freed by any technique that is known in the art, such as by shaking (sometimes referred to as “shakeout”) where the casting is shaken free of the modular 3D printed mold to reveal the cast. FIG. 11 depicts the completed cast 1100 which requires minimal cleanup post casting work, such as machining.

While the present disclosure has been illustrated by the description of exemplary embodiments thereof, and while the embodiments have been described in certain detail, the Applicant does not intend to restrict or in any way limit the scope of the appended claims to such detail. Additional advantages and modifications will readily appear to those skilled in the art. Therefore, the disclosure in its broader aspects is not limited to any of the specific details, representative devices and methods, and/or illustrative examples shown and described. Accordingly, departures may be made from such details without departing from the spirit or scope of the Applicant's general inventive concept.

In the above detailed description, reference is made to the accompanying drawings, which form a part hereof. In the drawings, similar symbols typically identify similar components, unless context dictates otherwise. The illustrative embodiments described in the present disclosure are not meant to be limiting. Other embodiments may be used, and other changes may be made, without departing from the spirit or scope of the subject matter presented herein. It will be readily understood that various features of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various features. Instead, this application is intended to cover any variations, uses, or adaptations of the present teachings and use its general principles. Further, this application is intended to cover such departures from the present disclosure as come within known or customary practice in the art to which these teachings pertain. Many modifications and variations can be made to the particular embodiments described without departing from the spirit and scope of the present disclosure as will be apparent to those skilled in the art. Functionally equivalent methods and apparatuses within the scope of the disclosure, in addition to those enumerated herein, will be apparent to those skilled in the art from the foregoing descriptions. It is to be understood that this disclosure is not limited to particular methods, reagents, compounds, compositions or biological systems, which can, of course, vary. It is also to be understood that the terminology used herein is for the purpose of describing particular embodiments only and is not intended to be limiting.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A method of forming a modular 3D printed mold from a plurality of 3D printed mold modules, the method comprising:
depositing additive material in accordance with a first digital 3D model to form a first green body;
hardening the first green body to form a first 3D printed mold module;
depositing additive material in accordance with a second digital 3D model to form a second green body;
hardening the second green body to form a second 3D printed mold module; and
moving the first 3D printed mold module into close proximity with the second 3D printed mold module to thereby form the modular 3D printed mold.

2. The method of claim 1, further comprising inspecting at least one of the first 3D printed mold module and the second 3D printed mold module for defects.

3. The method of claim 2, further comprising:
detecting a defect of predetermined classification in one of the first 3D printed mold module or the second 3D printed mold module;
removing from production the 3D printed mold module that contains the defect;
depositing additive material in accordance with the first digital 3D model or the second digital 3D model in order to form a first green body or second green body;
hardening the first green body or the second green body to replace the 3D printed mold module that contains the defect;
performing a test to detect whether a defect of predetermined classification exists in the third 3D printed mold module; and
moving the third 3D printed mold module into close proximity with the remaining first 3D printed mold module or second 3D printed mold module to thereby form the modular 3D printed mold.

4. The method of claim 1, wherein the first 3D printed mold module includes a protruding surface feature and the second 3D printed mold module includes a correspondingly shaped sunken surface feature.

5. The method of claim 1, wherein the first 3D printed mold module and the second 3D printed mold module are formed by a single 3D printer.

6. The method of claim 1, wherein the first 3D printed mold module and the second 3D printed mold module are formed by separate 3D printers.

7. A method of forming a casting, the method comprising:
depositing additive material in accordance with a first digital 3D model to form a first green body;
hardening the first green body to form a first 3D printed mold module;
depositing additive material in accordance with a second digital 3D model to form a second green body;
hardening the second green body to form a second 3D printed mold module;
moving the first 3D printed mold module into close proximity with the second 3D printed mold module to thereby form the modular 3D printed mold;
depositing molten metal into the modular 3D printed mold; and
hardening the molten metal contained within the modular 3D printed mold.

8. The method of claim 7, further comprising separating the hardened metal from the modular 3D printed mold.

9. The method of claim 8, wherein separating the hardened metal from the modular 3D printed mold comprises shaking the mold.

10. The method of claim 7, wherein the first 3D printed mold module includes a protruding surface feature and the second 3D printed mold module includes a correspondingly shaped sunken surface feature.

11. The method of claim 10, wherein the protruding surface feature and the correspondingly shaped sunken surface feature are nonsymmetrical.

12. The method of claim 10, wherein moving the first 3D printed mold module into close proximity with the second 3D printed mold module to thereby form the modular 3D printed mold further comprises aligning the protruding surface feature with the correspondingly shaped sunken surface.

13. The method of claim 12, wherein aligning the protruding surface feature with the correspondingly shaped sunken surface is configured to align at least one of a pattern cavity, sprue, riser, runner, or vent present in both the first 3D printed mold module and the second 3D printed mold module.

14. The method of claim 7, further comprising:
forming a 3D printed core by depositing additive material in accordance with a third digital 3D model to form a third green body and hardening the third green body; and
nesting the 3D printed core within the modular 3D printed mold formed by the first 3D printed mold module and the second 3D printed mold module.

15. A computer program product for forming a modular 3D printed mold from a plurality of 3D printed mold modules, wherein the computer program product is embodied by instructions on a non-transitory computer readable storage medium that, when executed by a processor, cause:
at least one 3D printer to deposit additive material to form a first 3D printed mold module in accordance with a first digital 3D model to form a first green body; and
at least one 3D printer to deposit additive material to form a second 3D printed mold module in accordance with a second digital 3D model to form a second green body
wherein the first 3D printed mold module includes a protruding surface feature and the second 3D printed mold module includes a correspondingly shaped sunken surface feature.
